(19) United States
(12) Patent Application Publication
(10) Pub. No.: US 2022/0233014 A1
(43) Pub. Date: Jul. 28, 2022

(54) SMART FRIED EGG COOKER

(71) Applicant: YONGSHENG HUANG, MARKHAM (CA)

(72) Inventor: YONGSHENG HUANG, MARKHAM (CA)

(21) Appl. No.: 17/577,079

(22) Filed: Jan. 17, 2022

Related U.S. Application Data
(60) Provisional application No. 63/140,503, filed on Jan. 22, 2021.

(51) Int. Cl. A47J 29/02; A47J 36/06; A47J 36/24

(52) U.S. Cl. CPC A47J 29/02; A47J 36/2483; A47J 36/06

(57) ABSTRACT

A smart fried egg cooker which can automatically cook a fried egg with different effects by choosing different cooking options is disclosed. The smart fried egg cooker includes a lid housing, a lid, key buttons, a control unit, a base housing, a tray, a heating component, a temperature sensor and a power unit. A method for cooking an egg using the egg cooker is also disclosed.

### CROSS REFERENCE TO RELATED APPLICATIONS

This application claims benefit from U.S. provisional application No. 63/140,503 filed on Jan. 22, 2021, the content of which is incorporated herein by reference in its entirety.

### TECHNICAL FIELD

The present disclosure relates to cooking appliances, in particular a device for cooking eggs that can automatically cook a fried egg with different effects by choosing different cooking options.

### BACKGROUND

Currently, when people cook a fried egg, they usually use a flat pan to cook it. An egg is cracked and the inner stuff of the egg, for example, yolk and/or egg white, is put on a flat pan. And the flat pan is placed on an electric or fire stove to be heated. However, an electric or fire stove can easily generate high temperature (higher than 400 Fahrenheit degree/205 Celsius degree), whereas an egg only needs 160 Fahrenheit degree (71 Celsius degree) to be cooked. It is very easy to overcook a fried egg by using pan on a stove. To cook a fried egg to a desirable effect, a lot of experience is required and the cooking needs to be watched all the time.

Therefore, there is a need for a device to facilitate cooking a fried egg.

### BRIEF SUMMARY

This disclosure provides a smart fried egg cooker that can detect the pan temperature and control the temperature to a desirable level to cook fried egg for a pre-set duration. With its intelligent function, the smart fried egg cooker can automatically cook a fried egg to different effects such as liquid yolk, solid yolk or fully cooked yolk. The egg cooker of this disclosure enables people without any experience to cook a fried egg to their desired effects without having to watch during the cooking process.

### BRIEF DESCRIPTION OF THE DRAWINGS

Reference will now be made, by way of example, to the accompanying drawings which show example embodiments of the present application, and in which:

FIG. 1 is a perspective view of one embodiment of present disclosure.

FIG. 2 is a perspective view of the embodiment of FIG. 1 in the open state.

FIG. 3 is an exploded view of the embodiment of FIG. 1.

FIG. 4 is an exploded view of the embodiment of FIG. 1 from another perspective.

FIG. 5 is a perspective view of the base housing.

FIG. 6 is a perspective view of the base housing from bottom.

FIG. 7 is a schematic diagram of the circuit connection structure of the present disclosure.

### DETAILED DESCRIPTION

In the following description, the technical solutions in the embodiment of present disclosure will be described in conjunction with the drawings of the embodiment of the present disclosure. Obviously, the described embodiment is only a part of the embodiments of the present invention. Based on the embodiment in this invention, all other embodiments obtained by those of ordinary skill in the art without creative work shall fall within the protection scope of this invention.

In the following description, the use of “first”, “second”, etc. are only used for descriptive purposes, and cannot be understood as indicating or implying their relative importance or implicitly indicating the number of indicated technical features. Therefore, the features defined with “first” and “second” may explicitly or implicitly include at least one of the features.

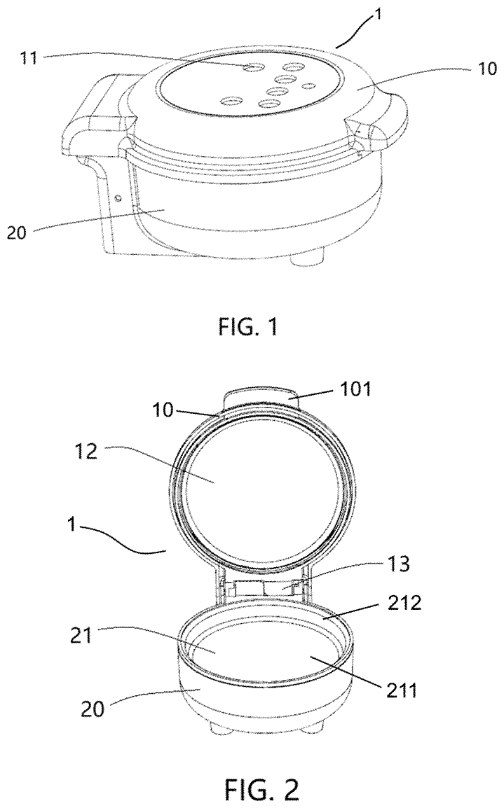

The present disclosure is related to a smart fried egg cooker. One embodiment of the present disclosure is shown in FIG. 1 through FIG. 7 inclusive.

Reference is now made to FIG. 1. The egg cooker 1 comprises a lid housing 10 and a base housing 20. Key buttons 11 are disposed on an exterior surface of the lid housing 10 to receive input. The lid housing 10 is sized and shaped to function as a cover for the base housing 20.

FIG. 2 shows the egg cooker 1 in an open state.

A lid 12 and a tray 21 are exposed. The lid 12 is generally round and is adapted to cover the tray 21. The lid housing 10 is also lifted, and a handle 101 is configured on the lid housing 10.

The lid 12 is utilized cover the tray 21 to keep the heat in the egg cooker 1 when a fried egg is being cooked.

The egg cooker 1 includes a hinge 13 that enables the lid 12 to be opened from the tray 21 about the hinge 13.

The tray 21 is disposed at least partially in the base housing 20.

The tray 21 is generally round and is adapted to hold the inner egg stuff after the egg is cracked. In some embodiments, the tray 21 is oval, oblong, or elongated and the lid 12 is of a corresponding shape. The cooking surface 211 is substantially flat.

The tray 21 includes a cooking surface 211 and a wall 212 that extends from the edge of the cooking surface 211. The cooking surface 211 is substantially flat.

The tray 21 is made of Aluminum, aluminum alloy, carbon steel, copper, or a combination thereof In some embodiments, the upper surface of the tray 21, including the cooking surface 211 and the inner surface of the wall 212, is coated with non-stick material such that when the inner stuff of the egg is put in the tray 21, the inner stuff of the egg does not stick to the tray 21.

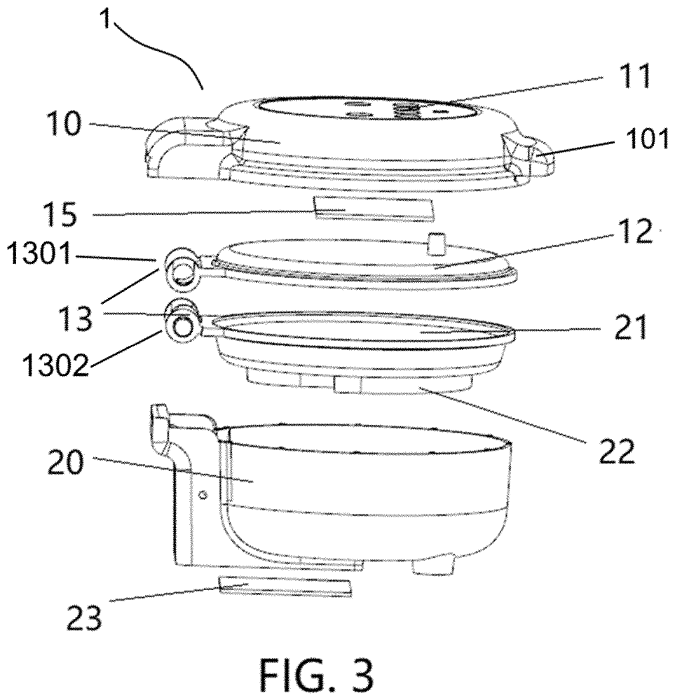

Reference is now made to FIG. 3.

The lid 12 is configured to be at least partially disposed in the lid housing 10. For example, the lid housing 10 is mounted on the lid. A handle 101 is configured on the lid housing to facilitate moving the lid housing 10. The lid 12 is connected to the lid housing 10 such that when the lid housing 10 is lifted, the lid 12 is also lifted.

A control unit 15 is disposed in the lid housing 10 between the lid 12 and the lid housing 10 and the control unit is operatively connected to the key buttons 11. In some embodiments, the control unit 15 is disposed in the base housing 20. In some embodiments, the control unit 15 is integrated with the key buttons 11, for example, the key buttons 11 are installed on the control unit 15.

The wall 212 is formed on the opening side of the tray 21 surrounding the cooking surface 211. Thus, the inner stuff of an egg can be kept in the opening side of the tray 21.

The first counterpart 1301 of the hinge joint 13 is formed on an edge of the tray 21. A second counterpart 1302 of the hinge joint 13 is formed at an edge of the lid 12 The first counterpart and the second counterpart cooperate to form the hinge joint 13 by which the tray 21 and the lid 12 are connected. The hinge joint 13 allows the lid 13 to be opened or closed with respect to the tray 21 about the hinge joint 13.

A heating component 22 is disposed on the side opposite the opening side of the tray 21 inside the base housing 20. The heating component 22 can generate heat by electrical power. For example, the heating component 22 may be resistance-based or induction-based. The heat can be transferred to the inner egg stuff through the tray 21.

The egg cooker 1 also includes a power unit 23 operatively connected to the heating component 22 and the control unit 15.

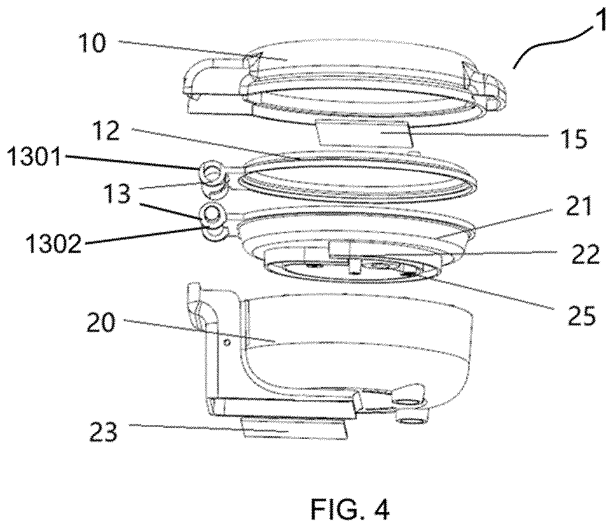

Referring to FIG. 4, a temperature sensor 25 is disposed on the side of the tray 21 opposite the cooking surface 211. The temperature sensor 25 is configured to detect the temperature of tray 21. The temperature sensor 25 is operatively connected to the control unit 15 such that the temperature data is transmitted to the control unit 15. In some embodiments, the temperature sensor 25 comprises one or more of thermistor, resistance temperature detector, or thermocouple.

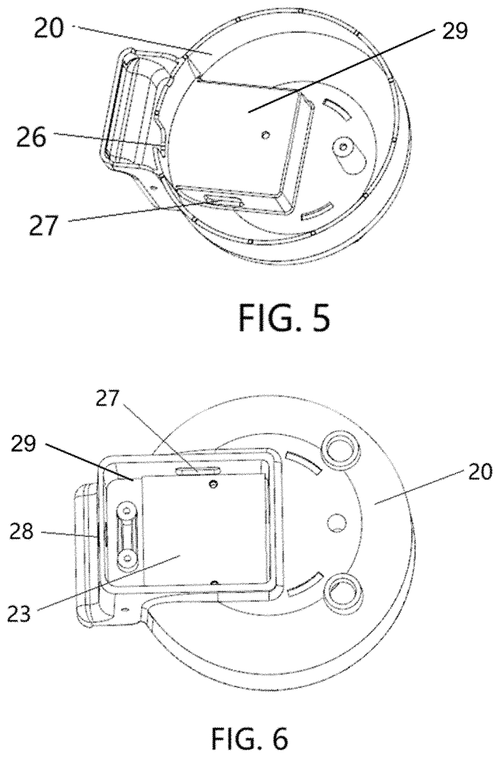

Reference is now made to FIGS. 5 and 6.

A first opening 26 is formed in the wall of the base housing 20. The first opening 26 allows the electrical wire to pass through, for example, to connect the power unit 23 and the control unit 15.

In the base housing 20 a compartment 29 is formed. The power unit 23 is disposed in the compartment 29.

On one side of the compartment wall a second opening 27 is formed for allowing electrical wires through. In some embodiments, the electrical wires from the power unit 23 can pass through the second opening 27 and connect to the heating component 22 and the control unit 15. A third opening 28 is formed on the wall of the compartment for allowing electrical wires. In some embodiments, an electrical wire from the power unit 23 can pass through the third opening 28 and plug in the electrical outlet.

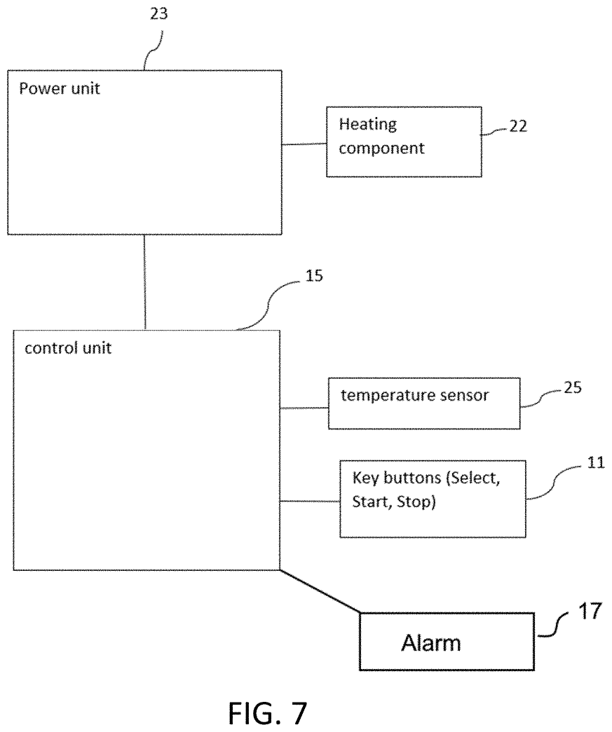

Reference is now made to FIG. 7.

The control unit 15 is operatively connected to the power unit 23 and the temperature sensor 25, for example, by electrical wires. The control unit 15 is configured to control the power of heating component 22 through the power unit 23. When a fried egg is being cooked, the control unit 15 receives the temperature of the tray 21 from the temperature sensor 25. If the temperature of the tray 21 is under the pre-set temperature, the control unit 15 will turn on the power at the heating component 22 or increase the power at the heating component 22. If the temperature of the tray 21 is over the pre-set temperature, the control unit 15 will turn the power of the heating component 22 off or decrease the power at the heating component 22. As such, the fried egg will be heated at within a predetermined range from the pre-set temperature.

The control unit 15 also controls the heating time when a fried egg is being cooked. The heating temperature and the heating time determine the cooking effect of a fried egg.

The key buttons 11 may include Select, Start, and Stop buttons. The Select button is utilized to select a desired cooking effect such as liquid yolk, solid yolk, or fully cooked. In some embodiments, the key buttons include individual mode buttons each corresponding to one desired effect, for example, liquid yolk, solid yolk, and fully cooked yolk, enabling the effect to be selected by pushing a single button. The Start button is used to start cooking. The Stop button is used to stop cooking. In some embodiments, the control unit 15 is configured to automatically control the whole cooking process, for example, including heating the tray, cooking the egg, and stopping heating of the tray, each for the predetermined time period. In some embodiments, the control unit 15 is configured to trigger an alarm 17 when the cooking is finished. The alarm may be visual, audio, or both.

A method for using the egg cooker 1 is also disclosed. One or more eggs were cracked and the inner stuff without the shell was put in the tray 21. The lid 12 was then closed over the tray 21. The desired cooking effect of fried egg was selected by using the key buttons. The Start button was pressed such that cooking was started. The cooking process, for example, including the cooking temperature and the heating time were controlled by the control unit 15 and the fried egg was cooked to the selected effect.

To cook the egg to have liquid yolk, the tray 21 containing cooking the inner stuff of the egg was heated from room temperature to about 130-140 degrees Celsius, which took about 2.5-3.5 minutes. The tray was kept at the temperature, by heating with the heating component 22 when needed, about 130-140 degrees Celsius for about 1-10 seconds. Preferably, the tray containing the inner stuff of the egg was heated to about 135 degrees Celsius in about 190 seconds and cooked at about 135 degrees Celsius for about 1 second.

To cook the egg to have solid yolk, the tray 21 containing the inner stuff of the egg was heated to about 110-130 degrees Celsius, preferably about 115-125 degrees Celsius, and more preferably about 120 degrees Celsius, which took about 2-3 minutes. The tray was then kept at about 110-130 degrees Celsius, preferably about 115-125 degrees Celsius, and more preferably about 120 degrees Celsius, by heating with the heating component 22 when needed, for about 70-90 seconds, preferably for about 75-85 seconds, and preferably for about 80 second. Afterwards, the heating component stopped heating the tray and the inner stuff of the egg was kept in the egg cooker 1 for about 140-160 seconds, preferably 145-155 seconds, and preferably 150 seconds.

To cook the egg to have full cooked yolk, the tray 21 containing the inner stuff of the egg was heated to about 110-130 degrees Celsius, preferably to about 115-125 degrees Celsius, and more preferably to about 120 degrees Celsius, which took about 2-3 minutes. The tray was then kept at about 110-130 degrees Celsius, preferably to about 115-125 degrees Celsius, and more preferably to about 120 degrees Celsius, by heating with the heating component 22 when needed, for about 150-170 seconds, preferably about 155-165 seconds, and more preferably about 160 seconds. Afterwards, the heating component stopped heating and the inner stuff of the egg was kept in the egg cooker for about 140-160 seconds, preferably 145-155 seconds, and preferably 150 seconds.

Once the cooking process was finished, an alarm 17 was triggered so that the Stop button was pressed to stop the cooking. In some embodiments, the cooking was automatically stopped by the control unit 15. The alarm 17 may be triggered after the cooking process was finished.

The lid 12 was opened and the cooked egg was removed from the egg cooker 1.

In some embodiments, fat, such as cooking oil or butter, was added in the tray 21 before the inner stuff of the egg was put in the tray 21.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A smart fried egg cooker comprising:
a round lid;
a lid housing mounted on the lid;
a control unit fastened in said lid housing;
key buttons installed on said control unit;
a base housing;
a tray comprising a flat side for heating an egg and a wall that is formed around an edge of the flat side;
a heating component mounted on a side of the tray opposite the flat side;
a temperature sensor mounted on the side of the tray opposite the flat side;
and a power unit;
wherein
the lid is hinged to the tray;
the control unit is operatively connected to the temperature sensor and the power unit; and
the power unit is operatively connected to the heating component.

2. The smart fried egg cooker of claim 1, wherein the tray is made of Aluminum, Aluminum alloy, carbon steel, copper, or a combination thereof

3. The smart fried egg cooker of claim 1, wherein the tray is coated with non-stick material.

4. The smart fried egg cooker of claim 1, wherein said tray is mounted in said base housing.

5. The smart fried egg cooker of claim 1, wherein a compartment is formed in said base housing.

6. The smart fried egg cooker of claim 5, wherein said power unit is mounted in said compartment.

7. An egg cooker, comprising
a lid that is at least partially disposed in the lid housing;
a tray configured to receive inner stuff of a cracked egg and to be covered by the lid
at least when the inner stuff of the cracked egg is being cooked;
a control unit for controlling a process of cooking the inner stuff of the cracked egg;
a heating component configured to heat the tray;
a temperature sensor configured to read a temperature of the tray, the temperature sensor operatively connected to the control unit such that the temperature of the tray is received by the control unit; and
a power unit operatively connected to the control unit and the heating component.

8. The egg cooker of claim 7, wherein
the control unit causes power from the power unit to the heating component to turn on or increase when the temperature of the tray is higher than a pre-set temperature; and
the control unit causes the power from the power unit to the heating component to turn off or decrease when the temperature of the tray is lower than a pre-set temperature.

9. The egg cooker of claim 8, wherein the control unit is configured to control a process of cooking the inner stuff of the cracked egg.

10. The egg cooker of claim 7, wherein
a first hinge counterpart is configured on the tray;
a second hinge counterpart is configured on the lid; and
the first hinge counterpart and the second hinge counterpart cooperate such that the lid if hingedly connected to the tray.

11. The egg cooker of claim 7, wherein the tray includes a cooking surface and a wall is formed around the edge of the cooking surface.

12. The egg cooker of claim 11, wherein the cooking surface and the wall are made of aluminum, aluminum alloy, carbon steel, copper, or a combination thereof.

13. The egg cooker of claim 7, wherein the cooking surface and the wall are coated with a non-stick coating.

14. The egg cooker of claim 7, further comprising buttons that are configured to receive input, wherein
the lid is at least partially disposed in a lid housing;
buttons are disposed on the lid housing, the; and
the buttons are operatively connected to the control unit.

15. The egg cooker of claim 7, wherein the tray is at least partially disposed in a base housing.

16. A method for cooking an egg, the method comprising:
putting inner stuff of a cracked egg in a tray that is configured to be heated by a heating component;
closing a lid to cover the tray;
selecting a desired effect for cooking the inner stuff of the cracked egg;
cooking the inner stuff of the cracked egg by a process controlled by a control unit.

17. The method of claim 16, wherein the desired effect is liquid yolk, and the process comprises:
heating the tray, in about 2.5-3.5 minutes, to about 130-140 degrees Celsius; and
keeping the covered tray at about 130-140 degrees Celsius for about 1-10 seconds.

18. The method of claim 16, wherein
the desired effect is solid yolk; and
the process comprises:
heating the covered tray, in about 2-3 minutes, from room temperature to about 110-130 degrees Celsius;
keeping the covered tray at about 110-130 degrees Celsius for about 70-90 seconds; and
keeping the inner stuff of the cracked egg in the covered tray for about 140-160 seconds without the tray being heated.

19. The method of claim 16, wherein
the desired effect is fully cooked yolk; and
the process comprises:
heating the tray, in about 2-3 minutes, from room temperature to about 110-130 degrees Celsius;
keeping the covered tray at about 110-130 degrees Celsius for about 150-170 seconds; and
keeping the inner stuff of the cracked egg in the covered tray for about 140-160 seconds without the tray being heated.

20. The method of claim 16, wherein the control unit triggers an alarm after the process is finished.
